(19) United States
(12) Patent Application Publication
(10) Pub. No.: US 2025/0352306 A1
(43) Pub. Date: Nov. 20, 2025

(54) METHOD OF POSITIONING ORTHODONTIC APPLIANCES ON TEETH

(71) Applicant: Swift Health Systems Inc., Irvine, CA (US)

(72) Inventor: Soo Jin Chung, Santa Monica, CA (US)

(21) Appl. No.: 19/205,096

(22) Filed: May 12, 2025

Related U.S. Application Data
(60) Provisional application No. 63/647,404, filed on May 14, 2024.

(51) Int. Cl. A61C 7/14; A61C 7/00

(52) U.S. Cl. CPC A61C 7/146; A61C 7/002

(57) ABSTRACT

An orthodontic appliance placement guide with instructions to position an orthodontic appliance, such as an orthodontic bracket, on a tooth of a patient at a position corresponding to a digital position of a digital appliance on a digital tooth in a virtual model of teeth of the patient. The orthodontic appliance placement guide can include representations of the tooth and the orthodontic appliance positioned thereon. The orthodontic appliance placement guide can indicate measurements between reference features of the orthodontic appliance and tooth. A clinician can take measurements when placing the orthodontic appliance on the tooth to guide placement of the orthodontic appliance as instructed by the orthodontic appliance placement guide.

### INCORPORATION BY REFERENCE TO ANY PRIORITY APPLICATIONS

This application claims the benefit of U.S. Provisional Application No. 63/647,404, filed May 14, 2024, which is incorporated by reference herein in its entirety. Any and all applications, if any, for which a foreign or domestic priority claim is identified in the Application Data Sheet of the present application is hereby incorporated by reference under 37 CFR 1.57.

### FIELD

The present disclosure relates in some aspects to methods of positioning orthodontic appliances, such as orthodontic brackets, on teeth.

### BACKGROUND

Orthodontic treatment can be digitally planned, including placement of orthodontic brackets on a patient's teeth. Placing orthodontic brackets on a patient's teeth at digitally planned locations can be critical to achieving predictable outcomes.

### SUMMARY

Teeth can be moved by bonding orthodontic brackets to the lingual or buccal surfaces of a patient's teeth and coupling an archwire to the bonded orthodontic brackets. The placement of the orthodontic brackets, configuration of the archwire, and/or other aspects of orthodontic treatment can be planned utilizing a digital model of the patient's teeth to achieve a planned outcome, such as a planned alignment of the patient's teeth. Accurate placement of orthodontic brackets on a patient's teeth according to the orthodontic treatment plan can be critical to achieving predicable outcomes. Bracket placement that deviates from digitally planned placement can yield results that deviate from those digitally planned, which can even include orthodontic brackets colliding with each other and/or teeth.

Indirect bonding trays are used to accurately place orthodontic brackets according to an orthodontic treatment plan. However, in some situations, use of an indirect bonding tray may be undesirable and/or not possible. For example, with crowded teeth conditions, there may be insufficient space to place an orthodontic bracket and/or use an indirect bonding tray to place an orthodontic bracket. Orthodontic treatment may still commence without one or more teeth intended for treatment having an orthodontic bracket bonded thereto. As teeth move (e.g., straighten and/or unravel) as treatment progresses, one or more teeth that were previously blocked out (e.g., could not have an orthodontic bracket placed and bonded thereto) may have sufficient space (e.g., tooth surface) to place and bond an orthodontic bracket. However, there may not be enough space to permit use of an indirect bonding tray; accordingly, a clinician, such as an orthodontist, may need to direct bond one or more orthodontic brackets to one or more of the patient's teeth without the assistance of an indirect bonding tray.

Disclosed herein are systems, apparatuses, and methods for accurately placing orthodontic brackets on a patient's teeth according to a digital plan, which can include without an indirect bonding tray or the like. For example, disclosed herein is an orthodontic bracket placement guide, which can also be referred to as an orthodontic appliance placement guide, instructional guide, orthodontic appliance placement guide, and/or graphical instruction guide. The orthodontic bracket placement guide can assist a clinician in placing an orthodontic bracket on a patient's tooth at a position and/or orientation consistent with a digitally planned position and/or orientation according to an orthodontic treatment plan.

The orthodontic bracket placement guide can include a graphical representation of a patient's tooth, which may include the unique characteristics of a patient's tooth. The orthodontic bracket placement guide can include a representation of an orthodontic bracket positioned and/or oriented with respect to the tooth as digitally planned. The orthodontic bracket placement guide can indicate measurements between one or more features (e.g., reference features, reference points, etc.) of the orthodontic bracket and one or more features of the tooth and/or other anatomical features to facilitate positioning and/or orienting of the orthodontic bracket with respect to the patient's tooth according to the digital orthodontic treatment plan. For example, the orthodontic bracket placement guide may indicate the distance between the incisal edge of the tooth and an occlusal-gingival midline of the orthodontic bracket. In some variants, the orthodontic bracket placement guide may indicate the distance between the incisal edge of the tooth and one or more features of the bracket, such as an occlusal edge of the bracket, gingival edge of the bracket, and/or one or more other features of the bracket. In some variants, the orthodontic bracket placement guide can indicate the distance between the mesial edge of the tooth and one or more features of the bracket, such as a mesial edge of the bracket, distal edge of the bracket, mesial-distal midline of the bracket, and/or one or more other features of the bracket. In some variants, the orthodontic bracket placement guide can include the distance between the distal edge of the tooth and one or more features of the bracket, such as a distal edge of the bracket, mesial edge of the bracket, mesial-distal midline of the bracket, and/or one or more other features of the bracket. In some variants, the orthodontic bracket placement guide can include a grid, overlaying the representation of the tooth and orthodontic bracket. The grid can include lines longitudinally oriented in the occlusal-gingival direction and/or mesial-distal direction. The lines of the grid can be equally spaced apart to visually convey distances between features of the orthodontic bracket and tooth. In some variants, the orthodontic bracket placement guide can include indicia, such as lines, that highlight one or more features of the bracket and/or tooth, which can at least include any of the bracket and/or tooth features shown and/or described herein. For example, the indicia (e.g., one or more lines) can be positioned (e.g., overlaid) on one or more features of the representations of the bracket and/or tooth. For example, the orthodontic bracket placement guide can include an indicia line extending at the occlusal-gingival midline of the bracket and another indicia line disposed at the incisal edge of the tooth. The orthodontic bracket placement guide can indicate distances between the one or more highlighted features (e.g., the occlusal-gingival midline of the bracket and the incisal edge of the tooth).

In use, a clinician can use the orthodontic bracket placement guide to orient and/or position an orthodontic bracket on the patient's tooth as digitally planned. The clinician can ensure that distances between bracket features and tooth features are consistent with those indicated in the orthodontic bracket placement guide by measuring those distances during placement. For example, the clinician can use a tool (e.g., probe, community periodontal index probe) to measure the distances to ensure consistency with those called out in the orthodontic bracket placement guide prior to bonding. In some variants, the orthodontic bracket placement guide may include angle measurements between features of the orthodontic bracket and tooth.

In some variants, the techniques described herein relate to an orthodontic appliance placement guide including: a representation of a tooth of a patient; a representation of an orthodontic appliance positioned on the representation of the tooth at a position corresponding to a digital position of a digital orthodontic appliance on a digital tooth in a virtual model of teeth of the patient; a first tooth indicia disposed at a first tooth reference feature of the representation of the tooth; a first appliance indicia disposed at a first appliance reference feature of the orthodontic appliance; and a first measurement between the first tooth reference feature and the first appliance reference feature, the first measurement configured to instruct a clinician as to relative positioning between the first tooth reference feature and the first appliance reference feature to guide placement of the orthodontic appliance on the tooth of the patient pursuant to the virtual model.

In some variants, the techniques described herein relate to an orthodontic appliance placement guide, wherein the orthodontic appliance is an orthodontic bracket.

In some variants, the techniques described herein relate to an orthodontic appliance placement guide, wherein the first measurement indicates a first distance.

In some variants, the techniques described herein relate to an orthodontic appliance placement guide, wherein the first tooth reference feature includes an incisal edge of the tooth.

In some variants, the techniques described herein relate to an orthodontic appliance placement guide, wherein the first appliance reference feature includes an occlusal surface of the orthodontic appliance.

In some variants, the techniques described herein relate to an orthodontic appliance placement guide, wherein the first appliance reference feature includes an occlusal-gingival midline of the orthodontic appliance.

In some variants, the techniques described herein relate to an orthodontic appliance placement guide, wherein the first tooth indicia includes a first line at the first tooth reference feature.

In some variants, the techniques described herein relate to an orthodontic appliance placement guide, wherein the first appliance indicia includes a second line at the first appliance reference feature.

In some variants, the techniques described herein relate to an orthodontic appliance placement guide, further including a grid with lines.

In some variants, the techniques described herein relate to an orthodontic appliance placement guide, wherein the lines of the grid are uniformly spaced apart from each other.

In some variants, the techniques described herein relate to an orthodontic appliance placement guide, further including: a second tooth indicia disposed at a second tooth reference feature of the representation of the tooth; a second appliance indicia disposed at a second appliance reference feature of the orthodontic appliance; and a second measurement between the second tooth reference feature and the second appliance reference feature, the second measurement configured to instruct the clinician as to relative positioning between the second tooth reference feature and the second appliance reference feature to guide placement of the orthodontic appliance on the tooth of the patient pursuant to the virtual model.

In some variants, the techniques described herein relate to an orthodontic appliance placement guide, wherein the second measurement indicates a second distance.

In some variants, the techniques described herein relate to a method of creating an orthodontic appliance placement guide, the method including: positioning a digital appliance on a digital tooth in a virtual model of a patient's teeth; creating an image of the digital tooth with the digital appliance positioned thereon, the image including a representation of the digital tooth and a representation of the digital appliance; adding a first tooth indicia at a first tooth reference feature of the representation of the digital tooth; adding a first appliance indicia at a first appliance reference feature of the representation of the digital appliance; and adding a first indication of a first measurement between the first tooth reference feature and the first appliance reference feature.

In some variants, the techniques described herein relate to a method, further including measuring between the first tooth reference feature and the first appliance reference feature.

In some variants, the techniques described herein relate to a method, wherein the digital appliance includes a digital orthodontic bracket.

In some variants, the techniques described herein relate to a method, wherein the first tooth reference feature includes an incisal edge of the digital tooth.

In some variants, the techniques described herein relate to a method, wherein the first appliance reference feature includes an occlusal surface of the representation of the digital appliance.

In some variants, the techniques described herein relate to a method, wherein the first appliance reference feature includes an occlusal-gingival midline of the representation of the digital appliance.

In some variants, the techniques described herein relate to a method, wherein the first tooth indicia includes a first line at the first tooth reference feature.

In some variants, the techniques described herein relate to a method, wherein the first appliance indicia includes a second line at the first appliance reference feature.

In some variants, the techniques described herein relate to a method, further including adding a grid.

In some variants, the techniques described herein relate to a method, wherein the first measurement includes a distance.

In some variants, the techniques described herein relate to a method, further including: adding a second tooth indicia at a second tooth reference feature of the representation of the digital tooth; adding a second appliance indicia at a second appliance reference feature of the representation of the digital appliance; and adding a second indication of a second measurement between the second tooth reference feature and the second appliance reference feature.

In some variants, the techniques described herein relate to a method, further including printing the orthodontic appliance placement guide.

In some variants, the techniques described herein relate to a method of placing an orthodontic appliance on a patient's tooth pursuant to placement of a corresponding digital orthodontic appliance on a digital tooth in a virtual model using an orthodontic appliance placement guide, the method including: acquiring an orthodontic appliance identified in an orthodontic appliance placement guide; identifying a tooth corresponding to the orthodontic appliance placement guide; and positioning the orthodontic appliance on the tooth with a first appliance reference feature of the orthodontic appliance a first measurement away from a first tooth reference feature by referencing the first appliance reference feature shown on a representation of the orthodontic appliance on the orthodontic appliance placement guide, the first tooth reference feature shown on the representation of the tooth on the orthodontic appliance placement guide, and the first measurement indicated on the orthodontic appliance placement guide.

In some variants, the techniques described herein relate to a method, further including bonding the orthodontic appliance on the tooth.

In some variants, the techniques described herein relate to a method, wherein the orthodontic appliance is an orthodontic bracket.

In some variants, the techniques described herein relate to a method, further including measuring the first measurement with a tool.

In some variants, the techniques described herein relate to a method, wherein the tool is a community periodontal index probe.

In some variants, the techniques described herein relate to a method, further including positioning the orthodontic appliance on the tooth with a second appliance reference feature of the orthodontic appliance a second measurement away from a second tooth reference feature by referencing the second appliance reference feature shown on the representation of the orthodontic appliance on the orthodontic appliance placement guide, the second tooth reference feature shown on the representation of the tooth on the orthodontic appliance placement guide, and the second measurement indicated on the orthodontic appliance placement guide.

### BRIEF DESCRIPTION OF THE DRAWINGS

These drawings are illustrative embodiments and do not present all possible embodiments of this invention. The illustrated embodiments are intended to illustrate, but not to limit, the scope of protection. Various features of the different disclosed embodiments can be combined to form further embodiments, which are part of this disclosure.

FIG. 1 illustrates an archwire.

FIG. 2 illustrates the archwire in a custom nonplanar shape.

FIG. 3 illustrates a connector of the archwire.

FIG. 4 illustrates an orthodontic bracket.

FIG. 5 illustrates the connector of FIG. 3 coupled with the orthodontic bracket of FIG. 4.

FIGS. 6A and 6B illustrate a bracket placement guide.

FIG. 7 illustrates the bracket placement guide with additional indicia.

FIG. 8 illustrates a measuring tool for positioning an orthodontic bracket on a patient's tooth pursuant to the instructions of an orthodontic bracket placement guide.

FIG. 9 illustrates a method of creating an orthodontic appliance placement guide, such as an orthodontic bracket placement guide.

FIG. 10 illustrates a method of placing an orthodontic appliance on a patient's tooth pursuant to placement of a corresponding digital orthodontic appliance on a digital tooth in a virtual model using an orthodontic appliance placement guide, such as an orthodontic bracket placement guide.

### DETAILED DESCRIPTION

Malocclusion of the teeth may be treated using orthodontic brackets and archwires to move the patient's teeth using sliding or non-sliding mechanics, as described in U.S. patent application Ser. No. 17/303,860, filed Jun. 9, 2021, now published as U.S. Publication No. 2021/0401548, the entirety of which is hereby incorporated by reference herein. Scans of a patient's teeth can be taken and a digital model (e.g., virtual model) of the patient's teeth can be created, at least in part, from the scans. The teeth of the digital model can be moved from positions of malocclusion (e.g., first positions) to second positions, which may be a planned alignment of the teeth such as a final planned alignment of the teeth.

Digital brackets can be placed, respectively, on the lingual or buccal surfaces of the teeth in the digital model. The digital brackets can be custom designed and/or selected from a library of digital brackets, which can include a variety of digital brackets with characteristics suitable for different teeth (e.g., molars, premolars, canines, incisors, etc.). In some variants, the digital brackets can be placed before moving the teeth of the digital model from the positions of malocclusion (e.g., first positions) to the second positions (e.g., planned alignment). The positions of the digital brackets on the teeth of the digital model in the second positions can correspond to a custom shape of an archwire that can move the patient's teeth from the first positions of malocclusion to the second positions. For example, digital markers can be positioned on and/or in the digital brackets to indicate positions for the connectors of the archwire with the archwire in a custom 3D shape that can move the patient's teeth to the second positions. In some variants, the digital brackets may include features to indicate placement of the digital markers. In some variants, a software program may automatically place the digital markers on and/or in the digital brackets. In some variants, the digital brackets may include digital markers.

An indirect bonding (IDB) tray can be formed based on the digital model. The teeth of the digital model, with the digital brackets disposed thereon, can be returned back to the positions of malocclusion that can reflect the current positions of the patient's teeth, which can be used to form an IDB tray. In some variants, the IDB tray can be formed based on the digital model with digital brackets placed on the maloccluded teeth of the digital model prior to movement of the digital teeth to the second positions. An IDB tray can be 3D printed based on the digital model and/or over molded on a physical model of the patient's teeth, which can be 3D printed, machined, and/or created from a mold. The IDB tray can be sized and shaped to fit over one tooth of the patient, a segment of the dental arch of the patient, and/or an entire dental arch of the patient. The IDB tray can include one or more wells (e.g., pockets, recesses, etc.) that can house orthodontic brackets therein and/or other orthodontic appliances. For example, each cavity of the IDB tray that can receive a patient's tooth can have a corresponding well. The wells can be positioned based on the corresponding positioning of the digital brackets in the digital model.

Orthodontic brackets can be placed in respective wells of the IDB tray with contact surfaces (e.g., bonding surfaces) exposed. An adhesive can be applied to the contact surfaces and the loaded IDB tray can be placed over the teeth of the patient, positioning the orthodontic brackets at locations on the teeth of the patient that correspond to the positioning of the digital brackets on the teeth in the digital model in the first positions. The orthodontic brackets can be bonded to the teeth of the patient, which can be facilitated by exposing the adhesive to air, light (e.g., UV light), heat, low temperatures, and/or chemical(s).

However, in some situations, use of an indirect bonding tray may be undesirable. For example, with crowded teeth conditions, there may be insufficient space to place an orthodontic bracket and/or use an indirect bonding tray to place an orthodontic bracket. Orthodontic treatment may still commence without one or more teeth intended for treatment having an orthodontic bracket bonded thereto. As teeth move (e.g., straighten and/or unravel) as treatment progresses, one or more teeth that were previously blocked out (e.g., could not have an orthodontic bracket placed and bonded thereto) may have sufficient space (e.g., tooth surface) to place and bond an orthodontic bracket. However, there may not be enough space to permit use of an indirect bonding tray; accordingly, a clinician, such as an orthodontist, may need to direct bond one or more orthodontic brackets to one or more of the patient's teeth without the assistance of an indirect bonding tray.

Disclosed herein are systems, apparatuses, and methods for accurately placing orthodontic brackets on a patient's teeth according to a digital plan, which can include without an indirect bonding tray or the like. For example, disclosed herein is an orthodontic bracket placement guide, which can also be referred to as an instructional guide, orthodontic appliance placement guide, and/or graphical instruction guide. The orthodontic bracket placement guide can assist a clinician in placing an orthodontic bracket on a patient's tooth at a position and/or orientation consistent with a digitally planned position and/or orientation according to an orthodontic treatment plan, which can include placing (e.g., bonding) an orthodontic bracket to a patient's tooth at the start of orthodontic treatment (e.g., prior to teeth movement caused by orthodontic treatment) and/or after orthodontic treatment has commenced (e.g., after teeth have moved as a result of orthodontic treatment).

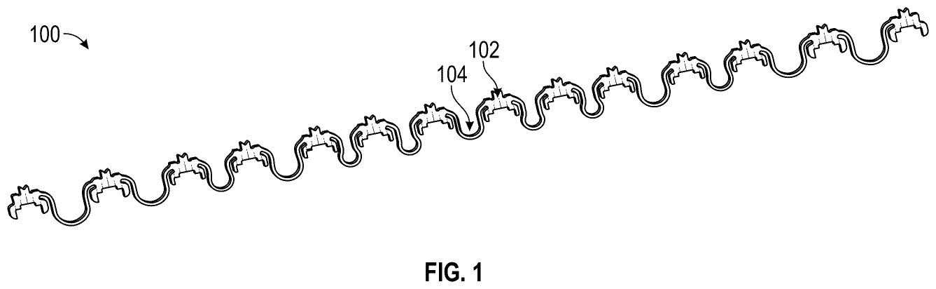

FIG. 1 illustrates an example embodiment of an archwire 100, which can also be referred to as an archform, orthodontic archform, and/or orthodontic archwire. The illustrated embodiment of the archwire 100 along with other embodiments of the archwire are described in U.S. patent application Ser. No. 17/303,860, filed Jun. 9, 2021, now published as U.S. Publication No. 2021/0401548, the entirety of which is hereby incorporated by reference herein. The archwire 100 can have a polygonal (e.g., rectangular, square), circular, oval, irregular, and/or other shaped cross-section. The archwire 100, as described herein, can be cut (e.g., laser, waterjet, punching, etc.) from a sheet of material, such as shape memory material, which can include shape memory alloys (e.g., nickel titanium such as Nitinol) and/or shape memory polymers. The archwire 100, as illustrated in FIG. 1, can have a planar (e.g., flat) shape. The archwire 100 can correspond to a segment of an upper or lower dental arch of a patient. The archwire 100 can correspond to an entirety of an upper or lower dental arch of a patient.

The archwire 100 can include a plurality of connectors or connector portions 102 (e.g., bracket connectors, anchors) that can be coupled to orthodontic brackets to install the archwire 100 in the mouth of a patient and/or be directly bonded to a patient's teeth without an orthodontic bracket. The archwire 100 can include a plurality of interproximal segments 104. The interproximal segments 104 can be disposed between adjacent connectors 102. The interproximal segments 104 can correspond to interdental spaces between adjacent teeth of the patient. The interproximal segment 104 can include loops. The loops can extend in a gingival direction when the archwire 100 is installed in the mouth, which can improve aesthetics and/or facilitate flossing. The loops can open to move adjacent teeth apart from each other. The loops can move toward closing to move adjacent teeth closer together. The loops can be various shapes, including U, T, tear-drop, triangular, rectangular, boot, and/or others. The loops of the archwire 100 can have varying rigidity. For example, the forces to move molars may be greater than other teeth; accordingly, the loops at the molars may be more rigid than loops not at molars. The rigidity can vary due to the curvature of the loop, shape of the loop, size of the loop, and/or width of the archwire 100 at the loop. In some variants, multiple archwires can be installed in succession one after the other in a patient's mouth during orthodontic treatment, which can include an initial archwire, intermediate archwire, and/or final archwire. The loops of the intermediate archwire may be more rigid than corresponding loops of the initial archwire, and the loops of the final archwire may be more rigid than the corresponding loops of the intermediate archwire. The loops can extend (e.g., curve) gingivally down from one connector 102 to an intermediate position and back up occlusally to another adjacent connector 102 such that the loop is open in an occlusal direction.

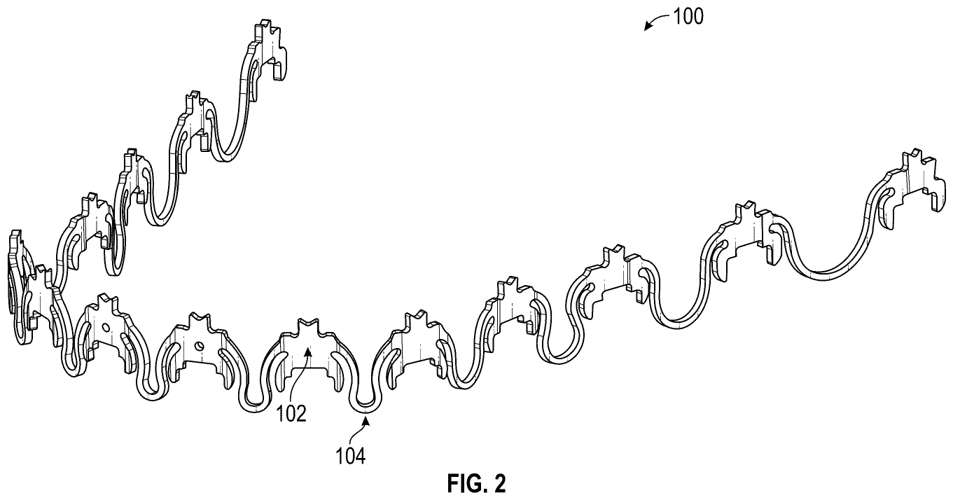

FIG. 2 illustrates the archwire 100 in a custom non-planar shape (e.g., custom 3D shape, custom memorized shape, custom memorized 3D shape). The custom non-planar shape can correspond to a planned alignment of a patient's teeth, which can include moving a patient's teeth toward or to the planned alignment. As described herein, the archwire 100 may correspond to a segment or the entirety of a patient's upper or lower dental arch. As illustrated in FIG. 2, the archwire 100 has an arch shape, which can correspond to the digitally planned alignment of a patient's dental arch.

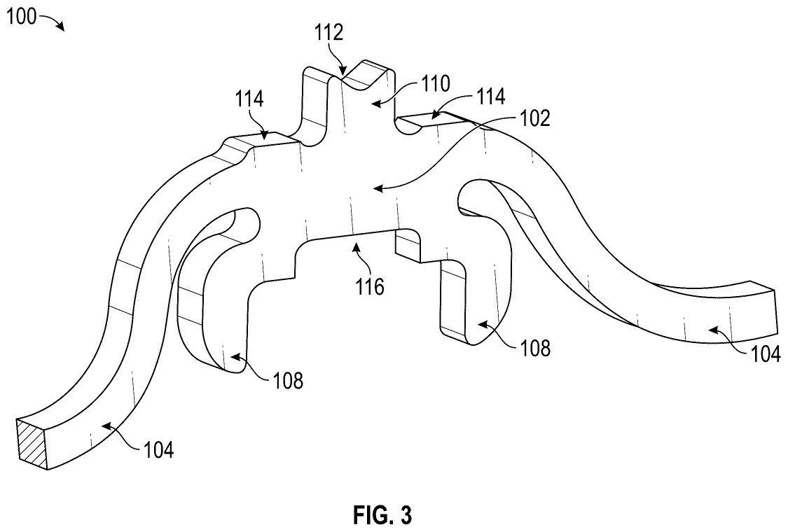

FIG. 3 illustrates the connector 102 (e.g., bracket connector, anchor, male fastener, connector portion) of the archwire 100. The connector 102 can be coupled to an orthodontic bracket such that the connector 102 does not slide with respect to the orthodontic bracket. In some variants, the connector 102 can be directly coupled (e.g., bonded, adhered) to the tooth of a patient. The connector 102 can be oriented in different orientations to move a tooth of a patient. The connector 102 can be disposed between adjacent interproximal segments 104. The interproximal segments 104, as described herein, can apply forces to adjacent connector(s) 102 that are coupled to orthodontic brackets to move teeth of a patient.

The connector 102 can have arms 108. The arms 108 can extend in a direction that is opposite that of a tab 110 (e.g., tongue) of the connector 102. The arms 108 can extend in at least an occlusal or gingival direction. The arms 108 can grip one or more features (e.g., mesial and distal sides of a feature) of an orthodontic bracket to help secure the connector 102 to the orthodontic bracket and/or provide improved control of a tooth of the patient. The arms 108 can grip a retainer of the orthodontic bracket. For example, the arms 108 can grip, hold, grasp, hug, snap around, and/or otherwise interface with the mesial and distal sides of the retainer. In some variants, the arms 108 can hold the archwire 100 (e.g., connector 102) in place on the orthodontic bracket as an operator positions a tool to secure the connector 102 to the orthodontic bracket. The arms 108 can include outer sides that are curved, which can help the arms 108 to better grip the retainer of the bracket.

A recess 116, which can also be referred to as a gap or cutout, can be disposed between the arms 108. The recess 116 can receive a C spring of the orthodontic bracket and/or other feature when the connector 102 is locked into a slot of the orthodontic bracket. The periphery defining at least a portion of the recess 116 can contact the C spring. The C spring can apply a force against the periphery of the recess 116 to push the connector 102 against stops of the bracket which can position a portion of the connector 102 under overhangs of the stops. The connector 102 can include contact surfaces 114 which can contact the stops of the orthodontic bracket. The contact surfaces 114 can be flat to provide a secure point of contact with the stops of the orthodontic bracket. The stops of the orthodontic bracket can have corresponding flat surfaces. The contact surfaces 114 can be disposed on a side of the connector 102 that is opposite the arms 108 and/or recess 116. The contact surfaces 114 can be disposed on opposing sides of the tab 110.

The tab 110 can be disposed on a side of the connector 102 that is opposite the arms 108 and/or recess 116. The tab 110 can be disposed in a gap between stops of the orthodontic bracket when the connector 102 is disposed in the slot of the orthodontic bracket. The tab 110 can contact inner sides of the stops, which can help to prevent sliding of the connector 102 in a mesial-distal direction relative to the orthodontic bracket. The tab 110 can extend in a gingival or occlusal direction. The tab 110 can include a groove 112. The groove 112 can be disposed on an end of the tab 110. The groove 112 can receive a tool to facilitate positioning the connector 102 into the slot of the orthodontic bracket or removing the connector 102 therefrom. The groove 112 can help to prevent inadvertent sliding of the tool being used to place the connector 102 into the slot of the orthodontic bracket. The connector 102 can include curves to reduce stress concentrators.

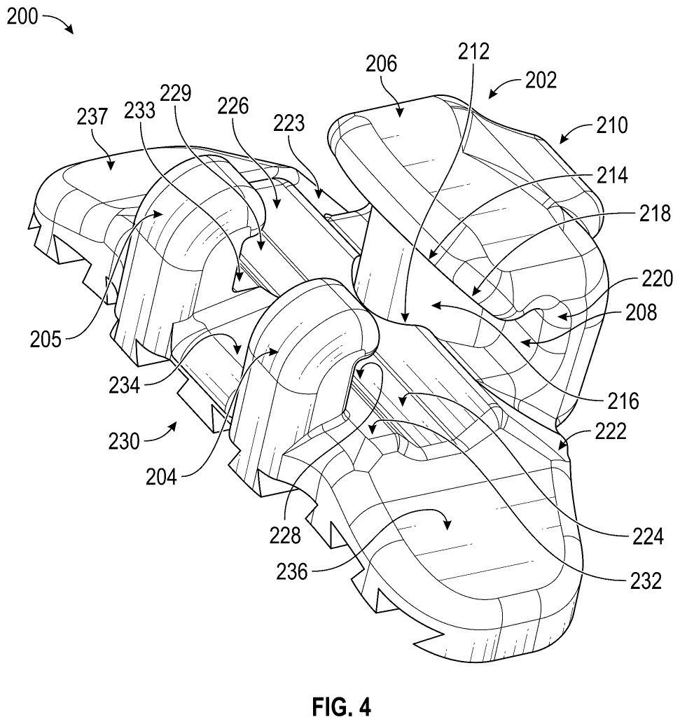

FIG. 4 illustrates an orthodontic bracket 200. The bracket 200 can be disposed on the lingual or buccal side of a patient's teeth. The bracket 200 can couple with the connector 102 of the archwire 100 to facilitate moving a patient's teeth using non-sliding mechanics. In some variants, the bracket 200 can have utility when used with archwires of different configurations than those described herein. The bracket 200 can include a slot 208, also referred to as a receiving region or receiving space, that can receive the connector 102 of the archwire 100 therein such that the connector 102 is prevented from sliding relative to the bracket 200 when installed in a patient's mouth. The slot 208 can be positioned between a retainer 202 and stops 204, 205. The slot 208 can be at least partially defined between the retainer 202, stops 204, 205, and a face 224 of the bracket 200.

As described herein, the retainer 202 can help to retain the connector 102 within the slot 208. The retainer 202 can at least be positioned proximate or at a gingival or occlusal side of the bracket 200. The retainer 202 can extend from the face 224 of the bracket 200. The retainer 202 can include one or more features to improve handling the bracket 200. For example, the retainer 202 can have a protuberance 210, also referred to as a bump, protrusion, or engagement region, that can be gripped by a tool during handling of the bracket 200. The protuberance 210 can extend in a gingival or occlusal direction.

The retainer 202 can include one or more features to improve retention of the connector 102 received in the slot 208 of the bracket 200. For example, the retainer 202 can include an overhang 206, e.g., extension. The overhang 206 can help hold the connector 102 within the slot 208. The overhang 206 can be offset from the face 224. The overhang 206 can extend over the slot 208 and/or face 224. The overhang 206 can include a curved portion 214 that extends over the slot 208 and/or face 224 of the bracket 200. The retainer 202 and/or overhang 206 can include an angled surface 218 that can facilitate the connector 102 being positioned within the slot 208 of the bracket 200 at an angle before being rotated toward the face 224 of the bracket 200 and being locked within the bracket 200, such as in the slot 208. The retainer 202 can include a recess 220, also referred to as a gap, undercut, cutout, space, etc., that can facilitate the connector 102 being rotated in and out of the slot 208 of the bracket 200 as detailed herein.

The bracket 200 can include a spring 216 (e.g., lock spring) that can facilitate locking the connector 102 of the archwire 100 within the bracket 200. The spring 216 can be a compressible material with resilient properties that can be biased to a certain position. The spring 216 can be a C spring, rounded spring, leaf spring, etc. The spring 216 can be housed within an opening 212. The opening 212 can be disposed through at least a portion of the retainer 202. The C spring 216 can be inserted into the opening 212 by way of a face of the bracket 200 that is opposite the face 224 (e.g., face of the bracket that faces the patient's tooth). The C spring 216 can be exposed to the slot 208 such that the connector 102 of the archwire 100 can contact the C spring 216 when positioned within the slot 208. The C spring 216 can be oriented with a longitudinal axis thereof oriented perpendicularly relative to the plane of the face 224. The opening 212 can be contoured and/or shaped to prevent titling and/or rattling of the C spring 216 within the opening 212. The opening 212 can be bounded by a periphery that can help to prevent the C spring 216 from deflecting beyond a desired range (e.g., beyond elastic deformation). With the connector 102 of the archwire 100 in the bracket 200, the C spring 216 can apply a force to the connector 102 that pushes the connector 102 against and/or at least partially under the stops 204, 205 such that the connector 102 is locked within the slot 208 of the bracket 200.

The stops 204, 205 can be proximate an opposite end of the bracket 200 relative to the retainer 202. In some variants, the stops 204, 205 can be in a mirrored configuration about a central plane of the bracket 200. The stops 204, 205 can include receiving spaces 228, 229, respectively. The receiving spaces 228, 229 can be at least partially bounded by extensions (e.g., overhangs) of the stops 204, 205. The receiving spaces 228, 229, which can also be referred to as pockets or cutouts, can receive, respectively, a portion of the connector 102 therein to secure the connector 102 within the slot 208. In some variants, the bracket 200 can include two stops 204, 205. In some variants, the bracket 200 may include one, three, four or more stops that can help retain the connector 102 of the archwire 100 within the bracket 200. The stops 204, 205 can be spaced apart from each other, which can be in the mesial-distal direction. A gap 234 can separate the stops 204, 205. The gap 234 can receive the tab 110 of the connector 102, as described herein. The portion of the face 224 spanning the gap 234 can be at least flat, angled, or curved. The portion of the face 224 spanning the gap 234 can be angled relative to other portions of the face 224 and/or curved at an end of the bracket 200.

The bracket 200 can include ramps 232, 233. The ramps 232, 233 can also be referred to as inclined surfaces, protrusions, angled surfaces, wedges, bumps, etc. The ramps 232, 233 can extend away from the face 224 of the bracket 200. The ramps 232, 233 can push the connector 102 against the stops 204, 205 to help secure the connector 102 within the slot 208. The ramps 232, 233 can push the connector 102 against the overhangs of the stops 204, 205. The ramps 232, 233 can include a flat surface that can engage the connector 102 when the connector 102 is secured within the slot 208. In some variants, the ramps 232, 233 can extend beyond a width of the stops 204, 205, respectively, which can help improve rotational control of a tooth by way of engagement with the connector 102.

The bracket 200 can include a protrusion 226 (e.g., bump). The protrusion 226 can extend from the face 224. The protrusion 226 can apply a force against the connector 102, when positioned within the slot 208, to push the connector 102 against the stops 204, 205 and/or overhang 206 of the retainer 202 to help secure the connector 102. The protrusion 226 can extend laterally beyond a width of the retainer 202, which can help improve rotational control of a tooth by way of engagement with the connector 102. The protrusion 226 can extend laterally beyond the stops 204, 205. In some variants, the opening 212 can disrupt (e.g., extend through) a portion of the protrusion 226.

The bracket 200 can include inclined surfaces 222, 223 that can facilitate inserting a connector 102 within the slot 208 of the bracket 200 at an angle before rotating the connector 102 toward the face 224 of the bracket 200 to lock the connector 102 into place. The inclined surfaces 222, 223 can be positioned on opposing sides of the retainer 202.

The bracket 200 can include lateral extensions 236, 237, which can also be referred to as lateral wings. The lateral extensions 236, 237 can help the bracket 200 to better control movement of a molar or other tooth. For example, the lateral extensions 236, 237 can facilitate better rotational control. The lateral extensions 236, 237 can also provide more surface area for a textured surface 230 for improved bonding. In some variants, the bracket 200 can omit the lateral extensions 236, 237, which may be desirable for one or more incisors due to available buccal tooth surface area.

The bracket 200 can include a textured surface 230, also referred to as a surface with undercuts, cuts, gaps, voids, and/or slots. The textured surface 230 can be disposed on a side of the bracket 200 that is opposite the face 224. The textured surface 230 can facilitate bonding the bracket 200 to a surface of the patient's tooth. Specifically, an adhesive applied to the textured surface 230 can bond the textured surface 230 to the surface of the patient's tooth. The textured surface 230 can provide an increased surface area to facilitate improved bonding compared to an un-textured surface.

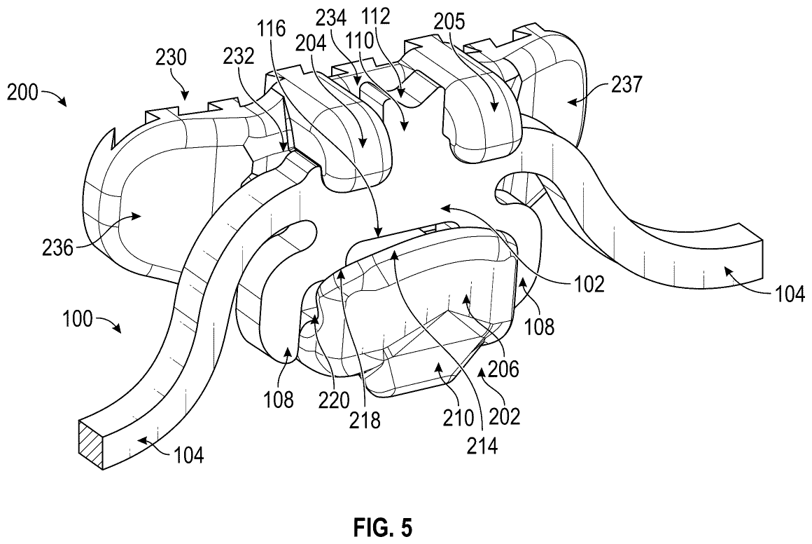

FIG. 5 illustrates the connector 102 coupled to the bracket 200. As illustrated, the connector 102 is disposed in the slot 208 of the bracket 200. The C spring 216 can push the connector 102 against the stops 204, 205 and/or under at least a portion of the stops 204, 205. The contact surfaces 114 can contact the stops 204, 205. The force applied by the C spring 216 can lock the connector 102 under the overhangs of the stops 204, 205 and the overhang 206 of the retainer 202. The protrusion 226 can apply a force against the connector 102 to push the connector 102 against the stops 204, 205 and/or overhang 206 of the retainer 202 to help secure the connector 102 within the bracket 200.

The bracket 200 and/or connector 102 of the archwire 100 can include modifications to accommodate the various teeth of the patient, such as the molars, premolars, canines, incisors, etc.

As described herein, accurate placement of a bracket on a patient's tooth according to a digitally planned placement can be critical to achieving digitally planned outcomes (e.g., digitally planned alignments). In some situations, use of an IDB tray may not be desirable or even possible to use in view of teeth movement to accurately place an orthodontic bracket. Accordingly, a clinician, such as an orthodontist, may direct bond an orthodontic bracket to a patient's tooth without an IDB tray. Disclosed herein are bracket placement guides that can enable a clinician to position and/or orient an orthodontic bracket on a patient's tooth for bonding thereon according to a digitally planned position and/or orientation pursuant to an orthodontic treatment plan.

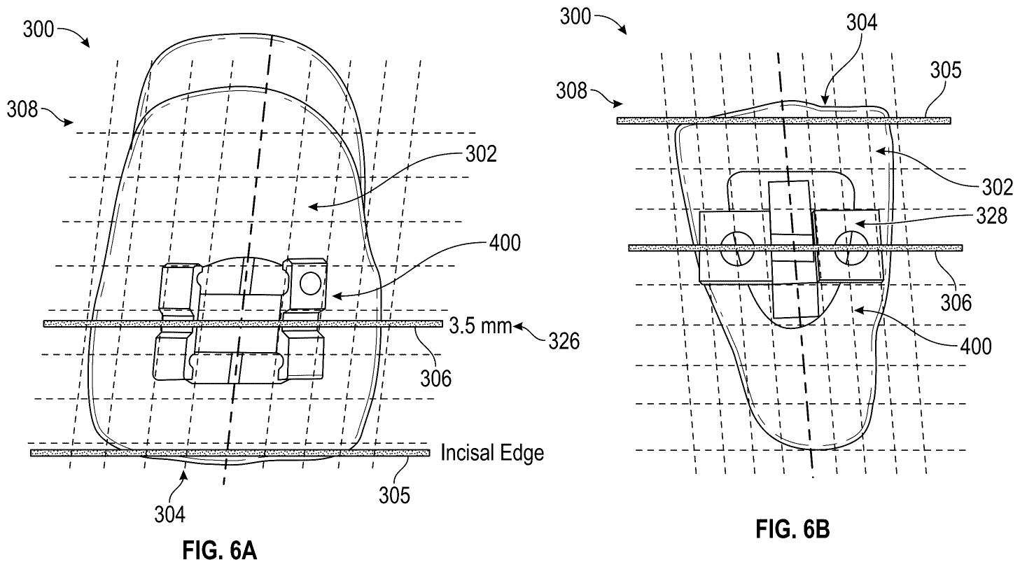

FIGS. 6A and 6B illustrate an orthodontic bracket placement guide 300, which can also be referred to as an instructional guide, orthodontic appliance placement guide, and/or graphical instruction guide. The bracket placement guide 300 can include a graphical representation of a patient's tooth 302, which may include the unique characteristics of a patient's tooth. In some variants, the graphical representation of a patient's tooth 302 can be a photo of the patient's tooth, 2D rendering of the patient's tooth, and/or a 3D rendering of the patient's tooth, which can include a 2D and/or 3D rendering from a virtual model of the patient's one or more teeth. The orthodontic bracket placement guide 300 can include a graphical representation of an orthodontic bracket 400, which can be the orthodontic bracket 200, disposed on the graphical representation of a patient's tooth 302 at a position and/or orientation consistent with a digitally planned position and/or orientation in a virtual model with a corresponding digital orthodontic bracket positioned on a corresponding digital tooth. As described herein, placing an orthodontic bracket on a patient's tooth in a position and/or orientation that is consistent with a digitally planned position and/or orientation can be critical to movement of the teeth to a digitally planned alignment from orthodontic treatment.

The orthodontic bracket placement guide 300 can include distances, angles, or other measurements between features of the orthodontic bracket 400 and the patient's tooth 302 to enable a clinician to bond the orthodontic bracket on the patient's tooth in a planned position and/or orientation. For example, the orthodontic bracket placement guide 300 can include a measurement 326 (e.g., distance, angle), such as 3.5 mm, between the occlusal-gingival midline of the orthodontic bracket 400 and an incisal tooth edge 304 of the patient's tooth 302. In some variants, the orthodontic bracket placement guide 300 can include one or more indicia highlighting (e.g., demarcating, indicating, emphasizing) feature(s) of the graphical representation of the orthodontic bracket 400 and/or graphical representation of the patient's tooth 302 used as reference features for measuring relative positioning and/or orientation of the orthodontic bracket and patient's tooth.

For example, as shown in FIGS. 6A and 6B, the orthodontic bracket placement guide 300 can include an occlusal-gingival midline indicia 306 (e.g., occlusal-gingival midline, which can be blue or another color) that visually indicates the midline of the graphical representation of the orthodontic bracket 400 in the occlusal-gingival direction. For example, the occlusal-gingival midline indicia 306 can include a line extending longitudinally in the mesial-distal direction that is disposed at the midline of the graphical representation of the orthodontic bracket 400 in the occlusal-gingival direction. The orthodontic bracket placement guide 300 can include an incisal tooth edge indicia 305 (e.g., line, which can be blue or another color) that visually indicates the incisal tooth edge 304 of the graphical representation of the patient's tooth 302. For example, the incisal tooth edge indicia 305 can include a line extending longitudinally in the mesial-distal direction that is disposed at the incisal tooth edge 304 (e.g., average position of the incisal tooth edge 304 in the occlusal-gingival direction) of the graphical representation of the patient's tooth 302. The orthodontic bracket placement guide 300 can indicate the distance between the occlusal-gingival midline indicia 306 and incisal tooth edge 304 (e.g., 3.5 mm). In some variants, the orthodontic bracket placement guide 300 can depict a perspective showing the side (e.g., lingual or buccal) of the patient's tooth upon which the orthodontic bracket is to be placed, as in FIG. 6A. In some variants, the orthodontic bracket placement guide 300 can depict a perspective through the side (e.g., lingual or buccal) of the patient's tooth upon which the orthodontic bracket is not placed to show a bonding surface 328 of the orthodontic bracket, as shown in FIG. 6B. The perspective illustrated in FIG. 6B can at least include the same position and/or orientation information as FIG. 6A.

The orthodontic bracket placement guide 300 can include a grid 308. The grid 308 can overlay the graphical representation of the patient's tooth 302 and/or graphical representation of the orthodontic bracket 400. The grid 308 can include lines longitudinally oriented in the occlusal-gingival direction and/or mesial-distal direction. The lines of the grid can be equally spaced apart to visually convey distances between features of the orthodontic bracket and tooth. For example, the lines extending in the occlusal-gingival direction and/or mesial-distal direction may be spaced one millimeter apart to enable a clinician to quickly determine distances between features of the graphical representation of the patient's tooth 302 and graphical representation of the orthodontic bracket 400. The orthodontic bracket placement guide 300 can include a legend that indicates the distances between grid lines and/or otherwise helps a clinician interpret the orthodontic bracket placement guide 300 accurately.

The orthodontic bracket placement guide 300 can include measurements (e.g., distances, angles) of the relative positioning between reference features of the graphical representation of the patient's tooth 302 and graphical representation of the orthodontic bracket 400. The orthodontic bracket placement guide 300 can include a measurement between two reference features. The orthodontic bracket placement guide 300 can include measurements between multiple reference features (e.g., a first measurement between a first pair of reference features and a second measurement between a second pair of reference features).

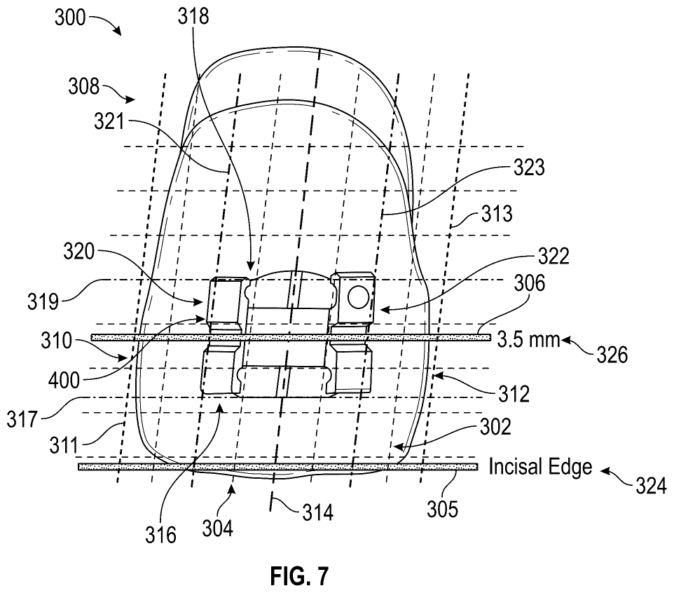

For example, as illustrated in FIG. 7, the orthodontic bracket placement guide 300 can at least use the mesial tooth edge 310, distal tooth edge 312, and/or incisal tooth edge 304 of the graphical representation of the patient's tooth 302 as reference features. The orthodontic bracket placement guide 300 can at least use the occlusal bracket edge 316, gingival bracket edge 318, mesial bracket edge 320, distal bracket edge 322, mesial-distal midline, and/or occlusal-gingival midline of the graphical representation of the orthodontic bracket 400 as reference features. The orthodontic bracket placement guide 300 can indicate measurements (e.g., distances, angels, etc.) between any of the foregoing reference features of the graphical representation of the patient's tooth 302 and graphical representation of the orthodontic bracket 400. In some variants, the orthodontic bracket placement guide 300 can include indicia highlighting (e.g., demarcating, indicating, emphasizing) one or more of the reference feature(s). For example, as illustrated in FIG. 7, the orthodontic bracket placement guide 300 can include an incisal tooth edge indicia 305 that corresponds to the incisal tooth edge 304, mesial tooth edge indicia 311 that corresponds to the mesial tooth edge 310, distal tooth edge indicia 313 that corresponds to the distal tooth edge 312, occlusal bracket edge indica 317 that corresponds to the occlusal bracket edge 316, mesial bracket edge indicia 321 that corresponds to the mesial bracket edge 320, distal bracket edge indicia 323 that corresponds to the distal bracket edge 322, gingival bracket edge indicia 319 that corresponds to the gingival bracket edge 318, mesial-distal midline indicia 314 that corresponds to the medial-distal midline of the graphical representation of the orthodontic bracket 400, and/or occlusal-gingival midline indicia 306 that corresponds to the occlusal-gingival midline of the graphical representation of the orthodontic bracket 400. The indicia can be in any color (e.g., blue, red, green, etc.). In some variants, indicia relating to the graphical representation of the patient's tooth 302 can be a first color and indicia relating to the graphical representation of the orthodontic bracket 400 can be a second color different than the first. The indicia can include various shapes, text, symbols, images, graphics, etc. The indicia, in some variants, can be a line, which can be of varying thicknesses. In some variants, indicia relating to the graphical representation of the patient's tooth 302 can be a first line width and indicia relating to the graphical representation of the orthodontic bracket 400 can be a second line width different than the first.

The orthodontic bracket placement guide 300 can include patient, tooth, and/or appliance (e.g., bracket) identifying information. For example, the orthodontic bracket placement guide 300 can include a patient name, identification number, and/or computer readable code to help associate the orthodontic bracket placement guide 300 with a patient. The orthodontic bracket placement guide 300 can include a tooth name and/or number (e.g., LR1, LL2, UR3, UL4), upper or lower arch indication, and/or other information to associate the orthodontic bracket placement guide 300 with a specific tooth of the patient. The orthodontic bracket placement guide 300 can include appliance identifying information (e.g., bracket identifying information), which can at least include an appliance type, appliance size, appliance material, and/or other features to assist a clinician in identifying the appliance associated with the orthodontic bracket placement guide 300.

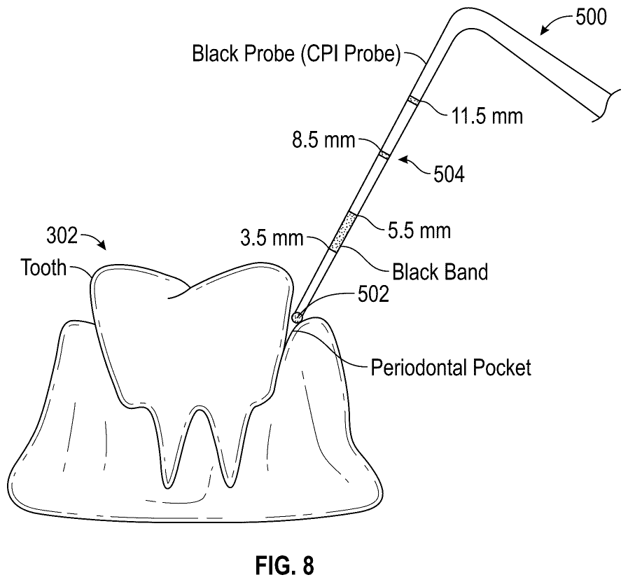

FIG. 8 illustrates a tool 500 (e.g., measuring tool, probe, periodontal probe, community periodontal index probe) that can be used to measure to position an orthodontic bracket on a patient's teeth pursuant to the instructions of the orthodontic bracket placement guide 300. The tool 500 can be used to measure distances to between reference features identified in the orthodontic bracket placement guide 300 to accurately position the orthodontic bracket on the patient's teeth pursuant to the instructions of the orthodontic bracket placement guide 300. The tool 500 can include measurement indicia 504, which can include measurement graduations, a measurement scale, distances, etc. The tool 500 can include a tip 502 (e.g., end), which can be round. A clinician can reference the measurement indicia 504 to measure distances between features called out on the orthodontic bracket placement guide 300 to accurately position an orthodontic bracket pursuant to the orthodontic bracket placement guide 300. In some variants, the tool 500 can be used to measure angles to enable a clinician to accurately place an orthodontic bracket.

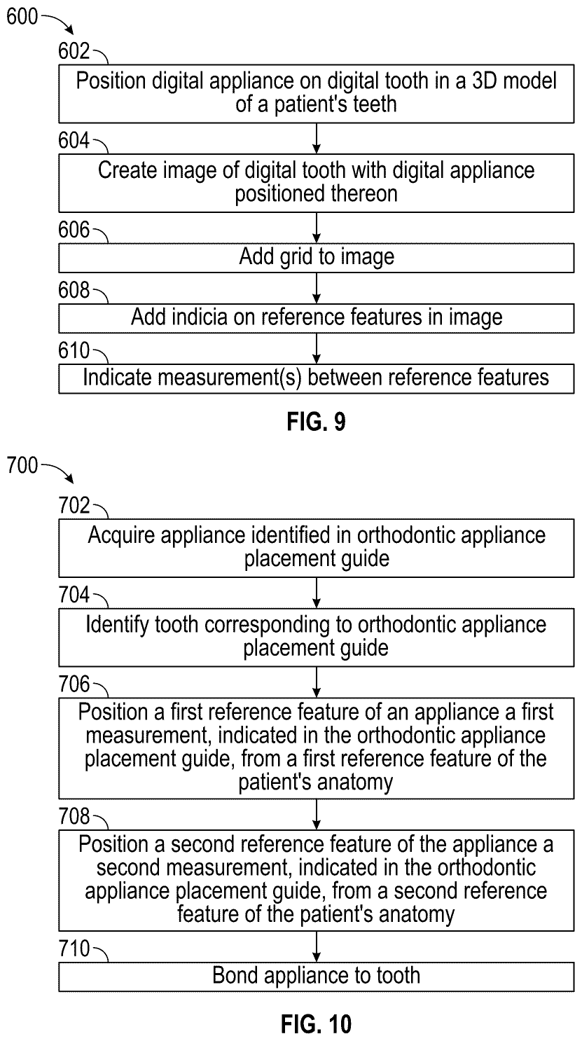

FIG. 9 illustrates a method 600 of creating an appliance placement guide, such as the orthodontic bracket placement guide 300. The method 600 can be performed with a computing device, which can at least include a display, processor, memory, controller, communication interface, user interface (e.g., pointing device(s), touch screen(s), button(s), toggle(s), etc.), power interface, and/or other computer hardware and/or software to perform the steps and/or tasks described herein This flow diagram is provided for the purpose of facilitating description of aspects of some embodiments. The diagram does not attempt to illustrate all aspects of the disclosure and should not be considered limiting.

At block 602, a digital appliance (e.g., digital orthodontic bracket) can be positioned on a digital tooth in a digital 3D model of a patient's teeth. As described herein, a digital 3D model (e.g., virtual model) of the patient's teeth can be created by a computing device based on one or more scans of the patient's teeth. The digital appliance can be selected from a library of digital appliances and/or be a custom-designed digital appliance. The digital appliance can be positioned on the digital tooth by a technician interfacing with the computing device, which can be by way of a user interface (e.g., pointing device). In some variants, the digital appliance can be automatically positioned on the digital tooth by the computing device, which can be based on placement criteria (e.g., minimum and maximum distances from anatomical features, other orthodontic appliances, etc.).

At block 604, an image of the digital tooth with the digital appliance positioned thereon can be created. The image can be a 2D image rendered from the digital 3D model. In some variants, the image can be a 3D image rendered from the digital 3D model. In some variants, the image of the digital tooth with the digital appliance positioned thereon can be isolated (e.g., separated) from the other anatomical features of the user and/or orthodontic appliance(s). In some variants, the image of the digital tooth with the digital appliance positioned thereon can be shown in its anatomical context (e.g., show neighboring teeth) and/or with other orthodontic appliances shown. The image can include representations of the digital tooth and/or digital appliance.

At block 606, a grid can be added to (e.g., overlaid on) the image (e.g., positioned on the representations of the digital tooth and digital appliance). The grid can, as described herein, include grid lines that are uniformly spaced to enable a clinician to readily determine distances between anatomical features and/or features of the orthodontic appliance.

At block 608, indicia, which can at least include the indica described herein, can be placed in (e.g., overlaid on) the image at reference features of the tooth and/or orthodontic appliance for guiding placement of the orthodontic appliance. In some variants, a technician operating the computing system can select anatomical features and/or features of the orthodontic appliance to be reference features for guiding placement of the orthodontic appliance. The technician and/or computing device can position indicia at the selected anatomical features and/or features of the orthodontic appliance. In some variants, the computing device can automatically select anatomical features and/or features of the orthodontic appliance to be reference features for guiding placement of the orthodontic appliance. In some variants, the reference features of the patient's anatomy (e.g., tooth) and/or orthodontic appliance (e.g., orthodontic bracket) can be preselected (e.g., predetermined). For example, in some variants, the incisal edge of a patient's tooth and occlusal edge of an orthodontic bracket may be preselected reference features for the orthodontic bracket. In some variants, the technician can select a type of indicia for a reference feature. In some variants, the computing device can automatically select a type of indicia for a reference feature.

At block 610, the measurement(s) between reference features can be indicated. In some variants, a technician operating the computing device can measure in the digital 3D model and/or image rendered from the digital 3D model a measurement (e.g., distance, angle) between reference features. In some variants, the computing device can automatically measure in the digital 3D model and/or image rendered from the digital 3D model a measurement (e.g., distance, angle) between reference features. In some variants, the technician can add an indication (e.g., text) of the measurement to the orthodontic appliance placement guide. In some variants, the computing device can automatically add an indication (e.g., text) of the measurement to the orthodontic appliance placement guide.

An appliance placement guide, such as the orthodontic bracket placement guide 300, can include the image of the digital tooth with the digital appliance, grid, indicia for reference features, and/or indicated measurement(s). A clinician can use the orthodontic appliance placement guide, as described herein, to position an orthodontic appliance (e.g., orthodontic bracket) according to placement of a corresponding digital orthodontic appliance on a digital tooth in a digital 3D model of a patient's teeth. The orthodontic appliance placement guide can be printed in physical form (e.g., printed to a sheet) and/or digitally referenced (e.g., viewed on a display screen or the like) by a clinician to guide positioning an orthodontic appliance on a patient's tooth.

FIG. 10 illustrates a method 700 of placing an orthodontic appliance on a patient's tooth pursuant to placement of a corresponding digital orthodontic appliance on a digital tooth in a virtual model using an orthodontic appliance placement guide, such as the orthodontic bracket placement guide 300. This flow diagram is provided for the purpose of facilitating description of aspects of some embodiments. The diagram does not attempt to illustrate all aspects of the disclosure and should not be considered limiting.

At block 702, a clinician can acquire an orthodontic appliance (e.g., orthodontic bracket) identified in the orthodontic appliance placement guide. As described herein, the orthodontic appliance placement guide can include appliance identifying information (e.g., bracket identifying information), which can at least include an appliance type, appliance size, appliance material, and/or other features to assist a clinician in identifying the appliance associated with the orthodontic bracket placement guide 300. The orthodontic appliance placement guide can include a representation of the orthodontic appliance, which the clinician can reference to determine the orthodontic appliance to be acquired.

At block 704, the clinician can identify a tooth corresponding to the orthodontic appliance placement guide. As described herein, the orthodontic appliance placement guide can include a tooth name and/or number (e.g., LR1, LL2, UR3, UL4), upper or lower arch indication, and/or other information to associate the orthodontic appliance placement guide with a specific tooth of the patient. In some variants, the clinician can identify a tooth corresponding to the orthodontic appliance placement guide by referencing the image (e.g., representation) of the tooth shown in the orthodontic appliance placement guide.

At block 706, the clinician can position a first reference feature of an orthodontic appliance (e.g., orthodontic bracket) a first measurement (e.g., distance, angle), indicated in the orthodontic appliance placement guide, from a first reference feature of the patient's anatomy (e.g., tooth). As described herein, the orthodontic appliance placement guide can include a measurement between a reference feature of the orthodontic appliance and a reference feature of the patient's anatomy (e.g., tooth) to orient the orthodontic appliance on the patient's tooth pursuant to the orientation of a corresponding digital orthodontic appliance on a digital tooth in the virtual model of the patient's teeth. Indicia can be disposed at the reference features as described herein, which help indicate reference features to a clinician. An indication (e.g., text) of the measurement between the reference features can be included in the orthodontic appliance guide. As described herein, the clinician can use a tool to measure between the reference features to position the orthodontic appliance on the patient's tooth pursuant to the orthodontic placement guide.

At block 708, the clinician can position a second reference feature of the orthodontic appliance a second measurement (e.g., distance, angle), indicated in the orthodontic appliance placement guide, from a second reference feature of the patient's anatomy (e.g., tooth). As described herein, the orthodontic appliance placement guide can include a measurement between a reference feature of the orthodontic appliance and a reference feature of the patient's anatomy (e.g., tooth) to orient the orthodontic appliance on the patient's tooth pursuant to the orientation of a corresponding digital orthodontic appliance on a digital tooth in the virtual model of the patient's teeth. Indicia can be disposed at the reference features as described herein, which can help indicate reference features to a clinician. An indication (e.g., text) of the measurement between the reference features can be included in the orthodontic appliance guide. As described herein, the clinician can use a tool to measure between the reference features to position the orthodontic appliance on the patient's tooth pursuant to the orthodontic appliance placement guide. In some variants, the orthodontic appliance placement guide can include further reference features for the appliance, further reference features for the patient's anatomy (e.g., tooth), and/or further measurements between the reference features.

At block 710, the clinician can bond the orthodontic appliance to the patient's tooth at the position instructed by the orthodontic appliance placement guide. In some variants, the clinician can couple the orthodontic appliance using techniques other than bonding.

This description has referenced accurately placing an orthodontic bracket pursuant to a digital plan using an orthodontic bracket placement guide and tool. However, the guide, tool, techniques, systems, methods, etc. described herein can be used to accurately place other orthodontic appliances pursuant to a digital plan using a guide and tool. For example, the other orthodontic appliances can at least include hook(s), button(s), bite turbo(s), tube(s), band(s), and/or any other orthodontic appliance(s).

It is intended that the scope of this present invention herein disclosed should not be limited by the particular disclosed embodiments described above. This invention is susceptible to various modifications and alternative forms, and specific examples have been shown in the drawings and are herein described in detail. This invention is not limited to the detailed forms or methods disclosed, but rather covers all equivalents, modifications, and alternatives falling within the scope and spirit of the various embodiments described and the appended claims. Various features of the orthodontic brackets and archwires described herein can be combined to form further embodiments, which are part of this disclosure.

Methods of using the orthodontic brackets and/or archwires (including device(s), apparatus(es), assembly(ies), structure(s) or the like) are included herein; the methods of use can include using or assembling any one or more of the features disclosed herein to achieve functions and/or features of the system(s) as discussed in this disclosure. Methods of manufacturing the foregoing system(s) are included; the methods of manufacture can include providing, making, connecting, assembling, and/or installing any one or more of the features of the system(s) disclosed herein to achieve functions and/or features of the system(s) as discussed in this disclosure.

Various other modifications, adaptations, and alternative designs are of course possible in light of the above teachings. Therefore, it should be understood at this time that within the scope of the appended claims the invention may be practiced otherwise than as specifically described herein. It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. For example, actions such as “tying a tie onto an orthodontic bracket” includes “instructing the tying of a tie onto an orthodontic bracket.” The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers (e.g., about 10%=10%), and also represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

What is claimed is:

1. An orthodontic appliance placement guide comprising:
a representation of a tooth of a patient;
a representation of an orthodontic appliance positioned on the representation of the tooth at a position corresponding to a digital position of a digital orthodontic appliance on a digital tooth in a virtual model of teeth of the patient;
a first tooth indicia disposed at a first tooth reference feature of the representation of the tooth;
a first appliance indicia disposed at a first appliance reference feature of the orthodontic appliance; and
a first measurement between the first tooth reference feature and the first appliance reference feature, the first measurement configured to instruct a clinician as to relative positioning between the first tooth reference feature and the first appliance reference feature to guide placement of the orthodontic appliance on the tooth of the patient pursuant to the virtual model.

2. The orthodontic appliance placement guide of claim 1, wherein the orthodontic appliance is an orthodontic bracket.

3. The orthodontic appliance placement guide of claim 1, wherein the first measurement indicates a first distance.

4. The orthodontic appliance placement guide of claim 1, wherein the first tooth reference feature comprises an incisal edge of the tooth.

5. The orthodontic appliance placement guide of claim 1, wherein the first appliance reference feature comprises an occlusal surface of the orthodontic appliance.

6. The orthodontic appliance placement guide of claim 1, wherein the first appliance reference feature comprises an occlusal-gingival midline of the orthodontic appliance.

7. The orthodontic appliance placement guide of claim 1, wherein the first tooth indicia comprises a first line at the first tooth reference feature.

8. The orthodontic appliance placement guide of claim 7, wherein the first appliance indicia comprises a second line at the first appliance reference feature.

9. The orthodontic appliance placement guide of claim 1, further comprising a grid with lines.

10. The orthodontic appliance placement guide of claim 1, further comprising:
a second tooth indicia disposed at a second tooth reference feature of the representation of the tooth;
a second appliance indicia disposed at a second appliance reference feature of the orthodontic appliance; and
a second measurement between the second tooth reference feature and the second appliance reference feature, the second measurement configured to instruct the clinician as to relative positioning between the second tooth reference feature and the second appliance reference feature to guide placement of the orthodontic appliance on the tooth of the patient pursuant to the virtual model.

11. A method of creating an orthodontic appliance placement guide, the method comprising:
positioning a digital appliance on a digital tooth in a virtual model of a patient's teeth;
creating an image of the digital tooth with the digital appliance positioned thereon, the image comprising a representation of the digital tooth and a representation of the digital appliance;
adding a first tooth indicia at a first tooth reference feature of the representation of the digital tooth;
adding a first appliance indicia at a first appliance reference feature of the representation of the digital appliance; and
adding a first indication of a first measurement between the first tooth reference feature and the first appliance reference feature.

12. The method of claim 11, wherein the digital appliance comprises a digital orthodontic bracket.

13. The method of claim 11, wherein the first tooth reference feature comprises an incisal edge of the digital tooth.

14. The method of claim 11, wherein the first appliance reference feature comprises an occlusal-gingival midline of the representation of the digital appliance.

15. The method of claim 11, wherein the first tooth indicia comprises a first line at the first tooth reference feature.

16. The method of claim 15, wherein the first appliance indicia comprises a second line at the first appliance reference feature.

17. A method of placing an orthodontic appliance on a patient's tooth pursuant to placement of a corresponding digital orthodontic appliance on a digital tooth in a virtual model using an orthodontic appliance placement guide, the method comprising:
acquiring an orthodontic appliance identified in an orthodontic appliance placement guide;
identifying a tooth corresponding to the orthodontic appliance placement guide; and
positioning the orthodontic appliance on the tooth with a first appliance reference feature of the orthodontic appliance a first measurement away from a first tooth reference feature by referencing the first appliance reference feature shown on a representation of the orthodontic appliance on the orthodontic appliance placement guide, the first tooth reference feature shown on the representation of the tooth on the orthodontic appliance placement guide, and the first measurement indicated on the orthodontic appliance placement guide.

18. The method of claim 17, wherein the orthodontic appliance is an orthodontic bracket.

19. The method of claim 17, further comprising measuring the first measurement with a tool.

20. The method of claim 17, further comprising positioning the orthodontic appliance on the tooth with a second appliance reference feature of the orthodontic appliance a second measurement away from a second tooth reference feature by referencing the second appliance reference feature shown on the representation of the orthodontic appliance on the orthodontic appliance placement guide, the second tooth reference feature shown on the representation of the tooth on the orthodontic appliance placement guide, and the second measurement indicated on the orthodontic appliance placement guide.
